(19) United States
(12) Patent Application Publication
(10) Pub. No.: US 2008/0111006 A1
(43) Pub. Date: May 15, 2008

(54) Adjustable rotation shower tap

(75) Inventor: Ching-Chen Shieh, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Globe Union Industrial Corp., Taichung (TW)

(21) Appl. No.: 11/599,400

(22) Filed: Nov. 15, 2006

(51) Int. Cl. B05B 1/18; B05B 1/34; B05B 3/04

(52) U.S. Cl. 239/383

(57) ABSTRACT

An adjustable rotation shower tap of present invention comprising: a tube with a pivot portion at one end. There is a guide tube that can be rotated by water pressure pivots inside the pivot portion. A rotation shower tap with plurality spout holes thereon mounts on the guide tube. A adjust member pivots on the pivot portion with a rub portion on the bottom side to against the rotation shower tap and provides friction to adjust the rotation speed. There is a limit portion on the adjust member. A resister that mounts on the pivot portion has a stopper thereon. The stopper locates in the limit portion of the adjust member to limit the rotate angle of the adjust member.

### BACKGROUND OF THE INVENTION

1. Field of the Invention

The present invention relates to the equipments in a bathroom and more particularly to an adjustable rotation shower tap.

2. Description of the Related Art

In prior art, there was a rotation shower tap which can provide rotation spout as disclosed in U.S. Pat. No. 6,896,201. This 201 prior art can provides rotation spout by the water pressure for clean and massage but there is a disadvantage in this prior art. Because of the rotation shower tap was pushed by the water pressure, the rotation speed of the rotation shower tap will increase as the water pressure goes higher. The main object of a rotation shower tap is to provide rotation spout for massage and to relax people. But, a rotation shower tap with high rotation speed usually give user psychological pressure and lose the main object.

### SUMMARY OF THE INVENTION

The one object of the present invention is to provide an adjustable rotation shower tap which can adjust the flow rate and rotation speed by the user friendly.

Another object of the present invention is to provide an adjustable rotation shower tap which can provide rotation spout and massage function.

The other object of the present invention is to provide an adjustable rotation shower tap which can adjust the flow rate.

To achieve those objects of the present invention, the adjustable rotation shower tap in present invention, comprising: A tube with a transfer portion at one end and a rotatable guide tube pivots inside the pivot portion. A rotation shower tap with plurality spout holes thereon for water to go through mounts on the guide tube. A adjust member pivots on the pivot portion with a rub portion on the bottom side to against the rotation shower tap and provides friction to adjust the rotation speed.

### BRIEF DESCRIPTION OF THE DRAWINGS

FIG. 1 is an appearance view of the first embodiment of present invention;

FIG. 2 is a front view of the first embodiment of present invention;

FIG. 3 is a section view of the first embodiment of present invention;

FIG. 4 is a appearance view about another type of the adjust member and limit portion in the first embodiment of present invention;

FIG. 5 is an appearance view of the second embodiment of present invention;

FIG. 6 is a front view of the second embodiment of present invention;

FIG. 7 is a section view of the second embodiment of present invention;

FIG. 8 is an appearance view of the third embodiment of present invention;

FIG. 9 is a bottom view of the third embodiment of present invention;

### DETAILED DESCRIPTION OF THE INVENTION

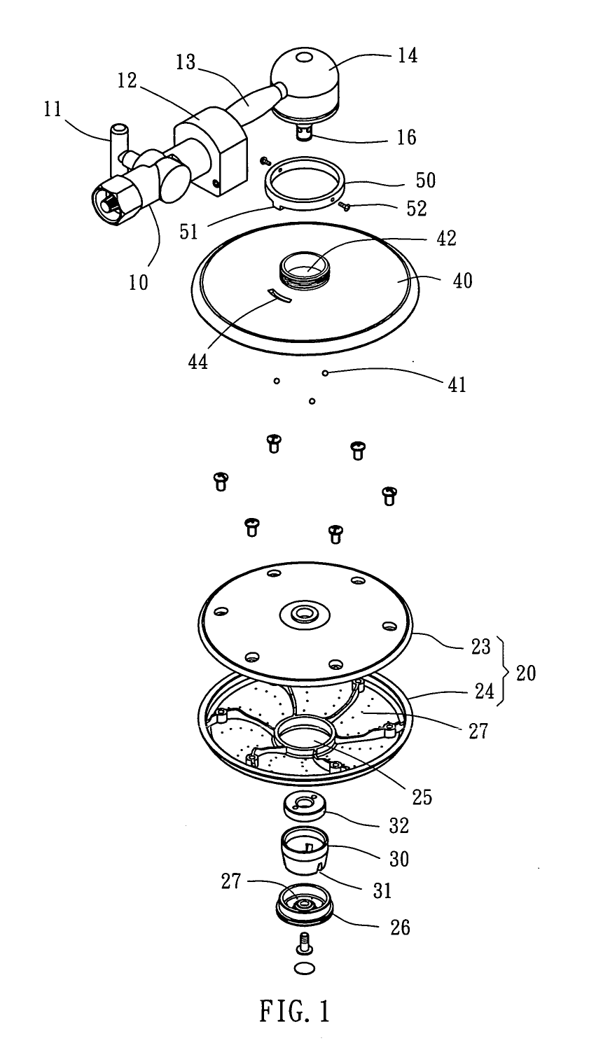

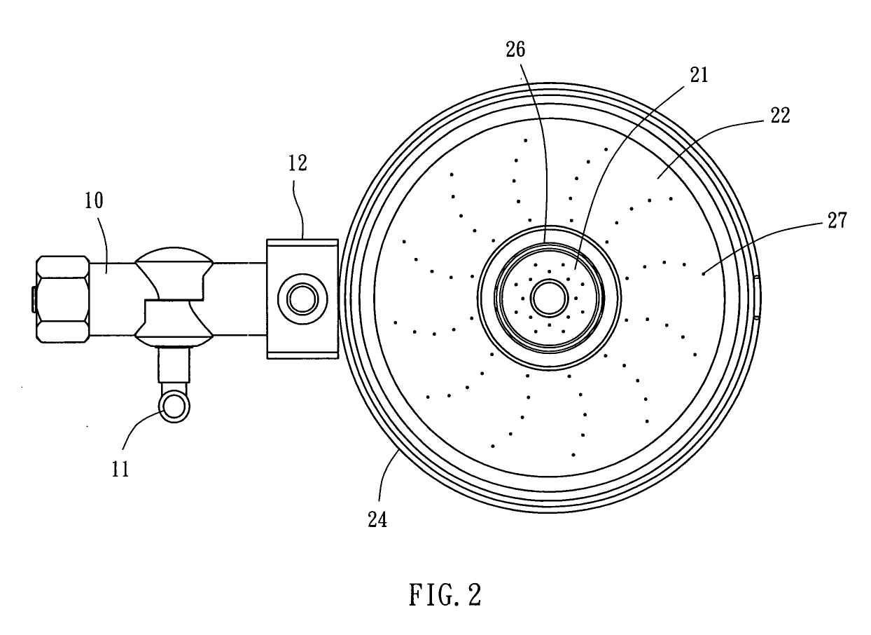

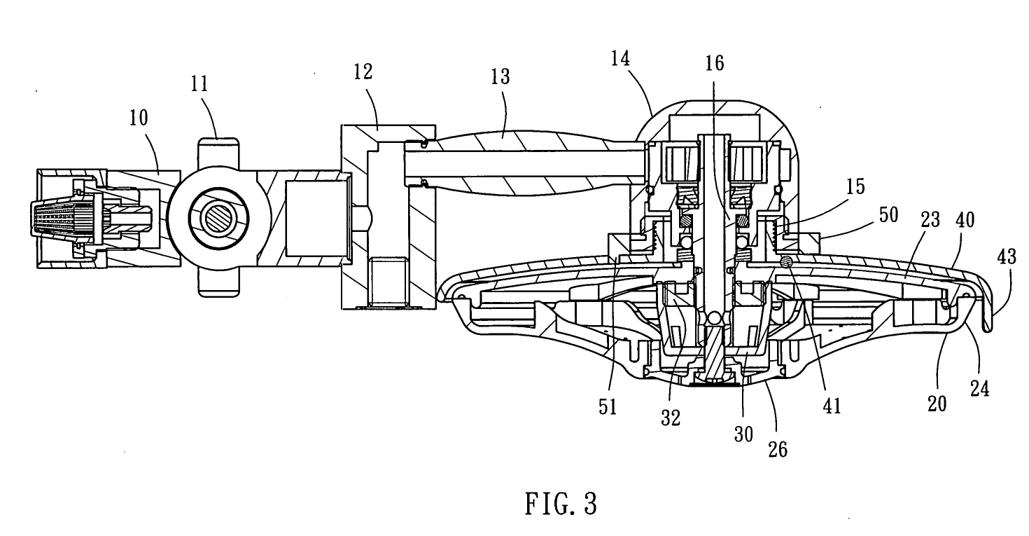

Referring to FIG. 1 to FIG. 4, an adjustable rotation shower tap of the first embodiment of present invention, comprising:

A tube 10 has a knob 11 thereon. One end of the tube 10 pivots on a transfer portion 12 and the transfer portion connects to an extending tube 13. The other end of the extending tube connects to a pivot portion 14. There are threads 15 on one edge of the pivot portion 14 and a guide tube 16 that can be rotated by water pressure pivots inside the pivot portion 14.

A rotation shower tap 20 with plurality spout holes thereon for water to go through mounts on the guide tube 16 and those spout holes separate into a main area 21 and a secondary area 22 around the main area. The rotation shower tap 20 is a rotation dish consists of an upper plate 23 and a lower plate 24 with taper shape in this embodiment of present invention. There is a hole 25 at the center of the lower plate 24 and a bung 26 with a hollow space plugs in the hole. There are plurality spout holes 27 on both of the bung 26 and the lower plate 24. Those spout holes separate in to a main area 21 which is in the bung 26 and a secondary area 22 which is in the lower plate 24.

A division controller 30 covers on the guide tube 16 and locates inside the main area. There are plurality gaps 31 around the division controller 30 thereon. In this embodiment of present invention, there is a jointer 32 with threads thereon below the guide tube 16. The division controller 30 has a tube body and one end of the tube body pivots on the jointer 32. There are three gaps 31 around the tube body near the other end.

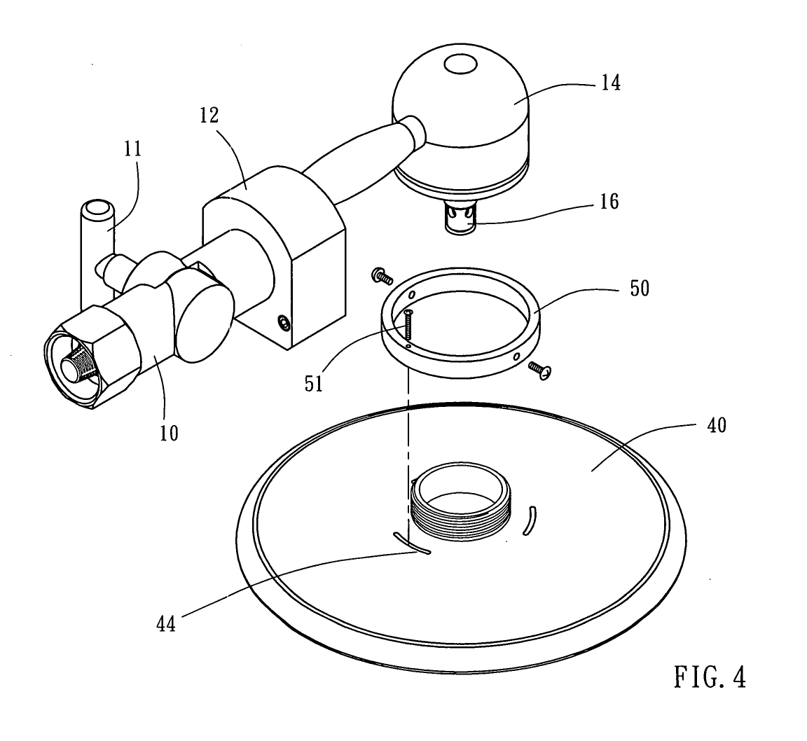

A adjust member 40 pivots on the pivot portion 14 with a rub portion 41 thereon to against the rotation shower tap 20 and provides friction to adjust the rotation speed. In this embodiment of present invention, the adjust member 40 is a plate with a through hole 42 at the center for the guide tube to go through. The adjust member pivots 40 on the pivot portion 14 with a thread portion that locates on the top of the adjust member. There are three balls on the bottom side of the adjust member 40 as a rub portion 41. There is a flange 43 on the edge of the adjust member 40. The adjust member 40 can be rotated by moving the flange 43. By the way, the distance between the adjust member 40 and the rotation shower tap 20 will change. In order word, the change will change the friction and adjust the rotation speed indirectly. There is a limit portion 44 on the topside of the adjust member 40. The limit portion 44 can be an arc ditch or three separate arc hole as shown in FIG. 4.

A resister 50 that mounts on the pivot portion 14 has a stopper 51 thereon. The stopper 51 locates in the limit portion 44 of the adjust member 40 to limit the rotate angle of the adjust member 40. In this embodiment, the resister 50 is a loop and fixes on the pivot portion 14 by studs 52. The stopper 51 can be a bulge as shown in FIG. 1 or a stud as shown in FIG. 4.

As those structures disclosed in the first embodiment, water will flow through the tube 10, the guide tube 16, the rotation shower tap 20 and then into the division controller 30 when user turn on the switch. At this moment, water will come out from those plurality gaps 31 to the main area 21 and the secondary area 22 of the rotation shower tap 20 and provide rotation spout for massage.

The user can rotate the adjust member 40 to change the distance between the adjust member 40 and the rotation shower tap 20. So, the friction from the rub portion 41 will be changed also. The friction will increase when the adjust member 40 moves forward to the upper plate 23 and force the rotation shower tap 20 hard to rotate. The friction will reduce when the adjust member 40 moves backward to the upper plate 23 and the rotation shower tap 20 can rotate easily. Thus, the rotation speed of the rotation shower tap 20 can be adjusted or even stop and the disadvantage of prior art can be eliminated. Meanwhile, the resister 50 will limit the adjust member 40 so the adjust member 40 can not rotate continually but in a predictive angle.

When doing the water division control, the division controller 30 can approach to the bung 26 and get away from the jointer 32 or approach to the jointer 32 and get away from the bung 26 by rotating the division controller 30. Those gaps 31 will move into the bung 26 of the lower plate 24 when the division controller 30 approaches to the bung 26. So, less water can flow out from the bung 26 to into the secondary area 22. Naturally, less water can come out from the spout of the secondary area. On the contrary, those gaps 31 will get away from the bung 26 of the lower plate 24 when the division controller 30 approaches to the jointer 32. So, more water can flow out from the bung 26 to into the secondary area 22. Thus, more water can come out from the spout hole of the secondary area. By this method, user can adjust the flow rate of the main area and the secondary area as he or she wants.

As those structures disclosed in the first embodiment, the rotation shower tap of present invention which can adjust the flow rate can provide a rotation spout for massage.

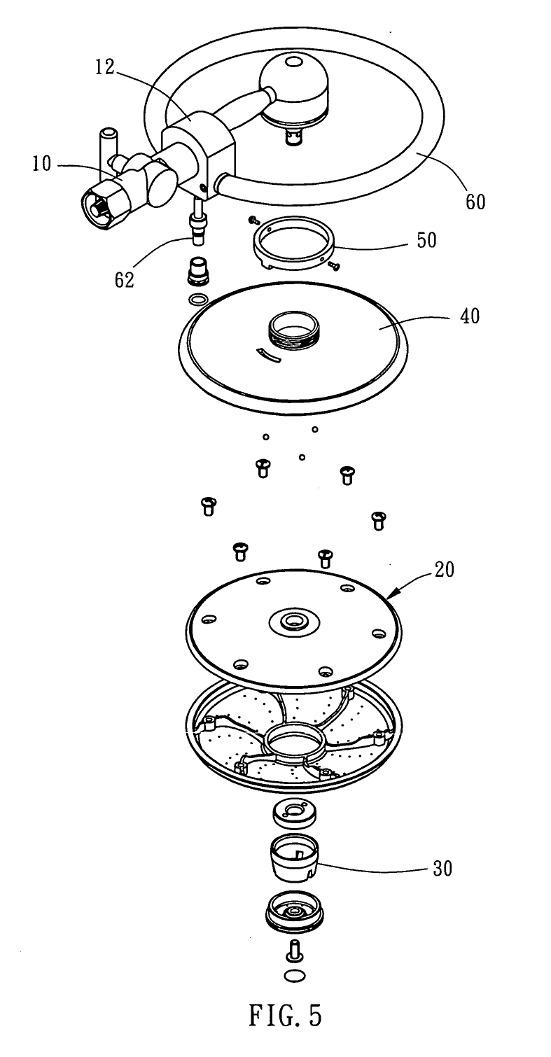

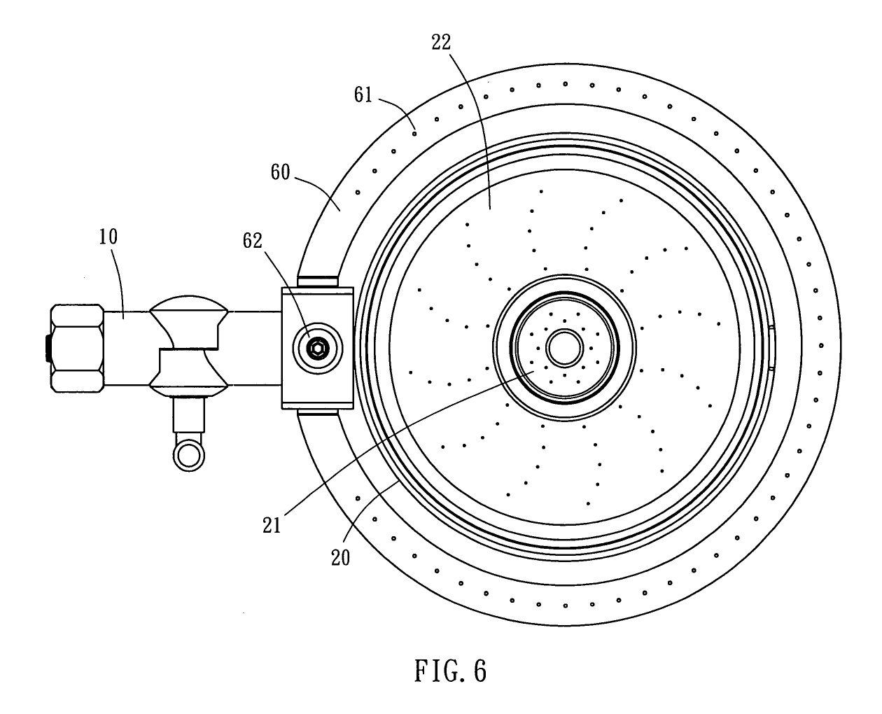

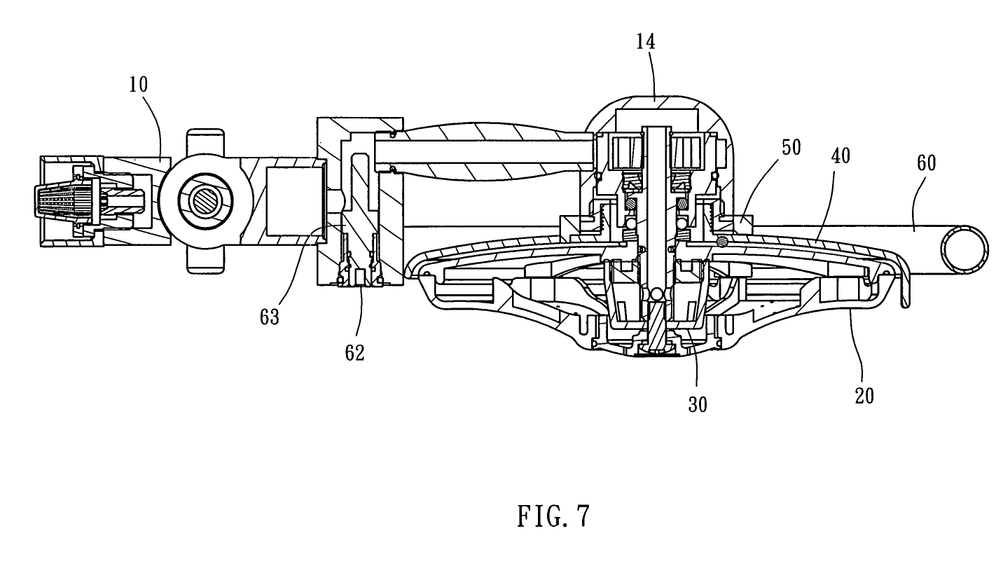

Referring to FIG. 5 to FIG. 7, the structures of the second embodiment are almost the same with the first embodiment of present invention. The differences are: an annular tube 60 with plurality spout 61 thereon mounts at the transfer portion 12 of the tube. There is a slide valve 62 in the transfer portion 12. The slide valve 62 has a rotatable axis with a blocker 63 on it. The water flow can be guided to the desired place by changing the place of the blocker 63.

As the structures disclosed in the second embodiment of present invention, some water will go through the extending tube 13 and into the guide tube 16 and other water will go into the annular tube 60. By rotating the slide valve 62, the blocker 63 can be controlled to separate water in the tube 10. When the blocker 63 blocks one end of the channel, water will not go into the annular tube 60 but into the rotation shower tap 20. When the blocker 63 not blocks any end of the channel, water can go into the rotation shower tap 20 and the annular tube 60 both.

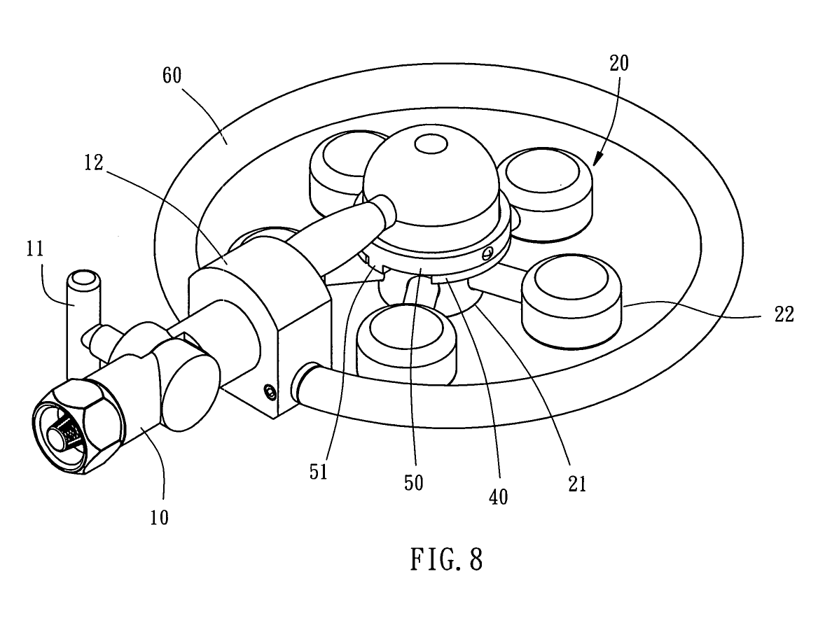

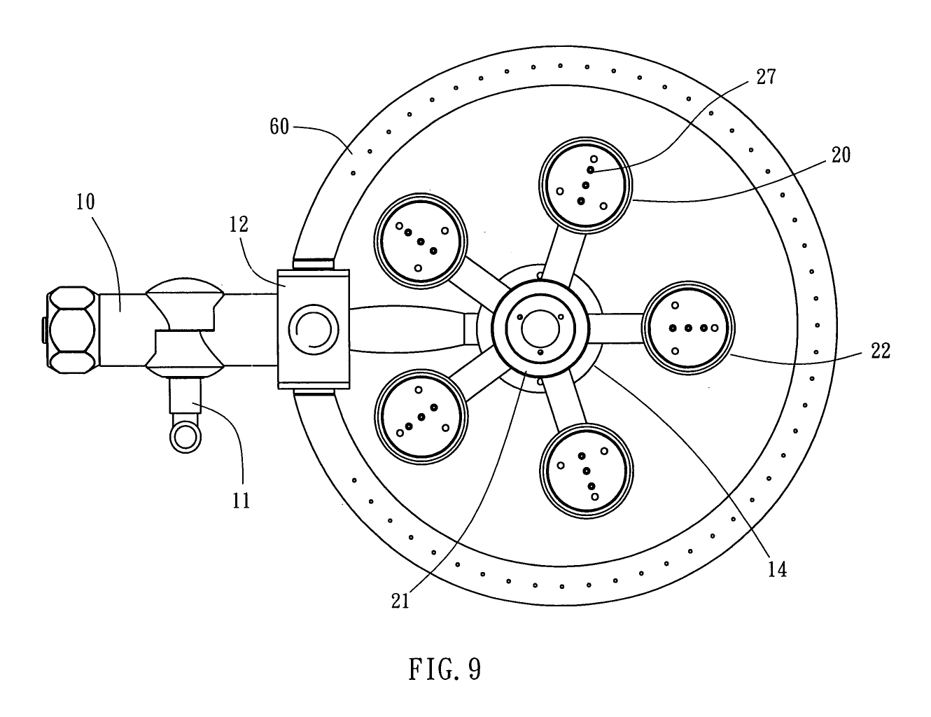

As the structures disclosed in present invention, those structures can apply on different types of the rotation shower tap also. Referring to FIG. 8 and FIG. 9, the third embodiment of present invention comprises almost the same structures as aforesaid embodiments. The rotation shower tap 20 in the third embodiment is not a single rotation dish but a rotator with plurality spout paws. The rotation shower tap of the third embodiment has a main area under the guide tube 16 and plurality pipes extrude from the main area. There is a secondary area at the end of each pipe. The secondary area has a head portion with ball shape in this embodiment. Each of the head portion has a spout plate with plurality spout holes mounted at the bottom side as shown FIG. 9. Water will go into the main area after passing through the guide tube and spout out from the spout holes of the main area and the secondary area. The adjust member 40 still can apply on this embodiment even the shape of the rotation shower tap is different with aforesaid embodiments. The adjust member also can control the rotation speed of the rotation shower tap and the division controller can control the flow of the water.

Those structures disclosed in present invention not only can apply on the hanging shower tap but also the hand-held shower tap certainly. Both these applications can reach the same functions and objects.

What is claimed is:

1. An adjustable rotation shower tap, comprising:
a tube with a transfer portion at one end and the transfer portion connects to an extending tube, the other end of the extending tube connects to a pivot portion and a guide tube pivots inside the pivot portion;
a rotation shower tap with plurality spout holes thereon for water to go through mounts on the guide tube;
a adjust member pivots on the pivot portion with a rub portion thereon to against the rotation shower tap and provides friction to adjust the rotation speed.

2. The shower tap as claimed in claim 1, wherein the adjust member has a limit portion on the topside.

3. The shower tap as claimed in claim 2, wherein a resister that mounts on the pivot portion has a stopper thereon and the stopper locates in the limit portion to limit the rotate angle of the adjust member.

4. The shower tap as claimed in claim 2, wherein the limit portion can be an arc ditch.

5. The shower tap as claimed in claim 2, wherein the limit portion can be an arc hole.

6. The shower tap as claimed in claim 3, wherein the stopper can be a bulge.

7. The shower tap as claimed in claim 3, wherein the stopper can be a stud.

8. The shower tap as claimed in claim 1, wherein an annular tube with plurality spout thereon mounts at the transfer portion.

9. The shower tap as claimed in claim 8, wherein the transfer portion has a slide valve inside.

10. The shower tap as claimed in claim 1, wherein the pivot portion has threads on one edge and the adjust member is a plate with a through hole at the center for the guide tube to go through, the adjust member pivots on the pivot portion with a thread portion that locates on the top and the rub portion locates on the bottom side.

11. The shower tap as claimed in claim 1, wherein the rotation shower tap is a rotation dish consists of an upper plate and a lower plate, there is a hole at the center of the lower plate and a bung with a hollow space plugs in the hole, there are plurality spout holes on both of the bung and the lower plate and those spout holes separate in to a main area which is in the center and a secondary area around it.

12. The shower tap as claimed in claim 1, wherein the rub portion is locates on the bottom side of the adjust member and consists of three balls.

13. The shower tap as claimed in claim 1, there are plurality pipes extrude from the main area and a secondary area sets at the end of each pipe.

14. The shower tap as claimed in claim 13, wherein each of the secondary area has a spout plate with plurality spout holes.

15. An adjustable rotation shower tap, comprising:
a tube with a transfer portion at one end and the transfer portion connects to an extending tube, the other end of the extending tube connects to a pivot portion, there are threads on the edge of the pivot portion and a guide tube pivots inside the pivot portion;
a rotation shower tap with plurality spout holes thereon for water to go through mounts on the guide tube, those spout holes separates to a main area and a secondary area around it;
a division controller covers on the guide tube and locates inside the main area, there are plurality gaps around the division controller thereon.

16. The shower tap as claimed in claim 15, wherein the division controller has a tube body and one end of the tube body pivots on the jointer, there are plurality gaps around the tube body near the other end.

17. The shower tap as claimed in claim 16, wherein one end of the division controller connects with a jointer that locates below the guide tube.

18. The shower tap as claimed in claim 15, wherein the rotation shower tap is a rotation dish consists of an upper plate and a lower plate with taper shape, there is a hole at the center of the lower plate and a bung with a hollow space plugs in the hole, there are plurality spout holes on both of the bung and the lower plate and those spout holes separate in to a main area which is in the bung and a secondary area which is in the lower plate.

19. The shower tap as claimed in claim 15, wherein the transfer portion has a annular tube with plurality spout holes thereon.

20. The shower tap as claimed in claim 19, wherein the transfer portion has a slide valve inside.
